(19) United States
(12) Patent Application Publication
(10) Pub. No.: US 2011/0314925 A1
(43) Pub. Date: Dec. 29, 2011

(54) DEFLECTION TESTING APPARATUS AND METHOD FOR USING

(76) Inventor: David Robert Loveland, Delta, CO (US)

(21) Appl. No.: 13/169,382

(22) Filed: Jun. 27, 2011

Related U.S. Application Data
(60) Provisional application No. 61/358,612, filed on Jun. 25, 2010.

(51) Int. Cl. G01N 3/00

(52) U.S. Cl. 73/788

(57) ABSTRACT

An apparatus for testing the ability of a material or component to deflect comprises a table on which a component or workpiece made of the material is mounted. The workpiece is mounted using a suitable holding and supportive device. The supportive device includes a fulcrum on which the workpiece is partially supported. A loading device is used to apply a load to the workpiece. A computer or PLC in operable communication with the loading device is used to operate the apparatus and assess the ability of the material of the workpiece to deflect. A process used to assess the testing of a material comprises the steps of deflecting a workpiece of the material and measuring at least one of a force used to deflect the workpiece and a distance the workpiece is deflected.

### CROSS-REFERENCE TO RELATED APPLICATIONS

This patent application claims priority benefit under 35 U.S.C. § 119(e) of copending, U.S. Provisional Patent Application Ser. No. 61/358,612, filed Jun. 25, 2010, the disclosure of this U.S. patent application is incorporated by reference herein in its entirety.

### TECHNICAL FIELD

The present invention relates generally to an apparatus for testing the ability of a material to deflect and, more particularly, to an apparatus and method for testing and assessing the ability of a component to deform.

### SUMMARY

In one aspect, the present invention resides in an apparatus for testing the ability of a material or component to deflect. Such an apparatus comprises a table on which a component or piece of material (hereinafter referred to as “workpiece”) is mounted. The workpiece is mounted using a suitable holding and supportive device. The supportive device includes a fulcrum on which the workpiece is partially supported. A loading device is used to apply a load to the workpiece. A computer or PLC in operable communication with the loading device is used to operate the apparatus and assess the ability of the material of the workpiece to deflect.

In another aspect, the present invention resides in a process used to assess the testing of a material. This process comprises the steps of deflecting a workpiece of the material and measuring at least one of a force used to deflect the workpiece and a distance the workpiece is deflected.

### BRIEF DESCRIPTION OF THE DRAWINGS

FIG. 1 is a perspective view of an apparatus for testing and assessing the ability of a material to deflect.

FIG. 2 is a perspective view of a workpiece holder and a loading device mounted on a table of the apparatus of FIG. 1.

FIG. 3 is a perspective view of the workpiece holder used with the apparatus of FIG. 1.

FIG. 4 is a front view of the apparatus of FIG. 1 during a process of testing a workpiece.

FIG. 5 is a front view of the workpiece holder and loading device during a process of testing a workpiece.

FIG. 6 is a flowchart representation of a process of testing the workpiece.

### DETAILED DESCRIPTION

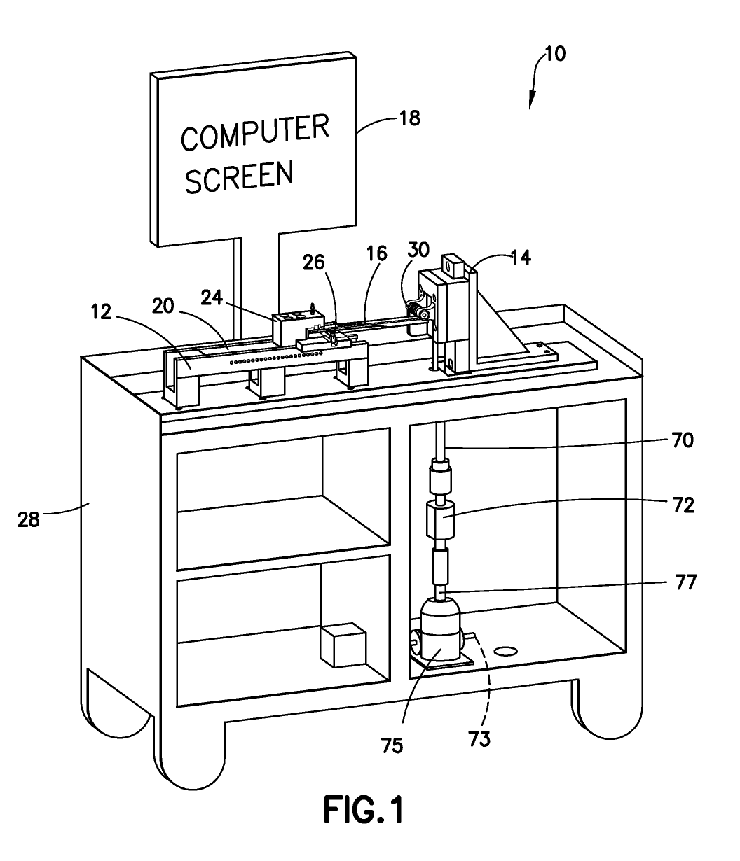

Referring now to FIG. 1, an apparatus for testing and assessing the ability of a material to deflect is designated generally by the reference number 10 and is hereinafter referred to as “apparatus 10.” Apparatus 10 comprises a table 12 and a loading device 14. The loading device 14 is located proximate the table 12 and is communicable with a workpiece 16 comprising the material mounted on the table. The loading device 14 is in operable communication with a PLC/computer (hereinafter “PLC 18”) having a screen. In any of the embodiments described herein, the workpiece 16 may be a component of an archery bow (e.g., a limb or spring or the like) made from either a unitary material or a composite material. The present invention is not limited in this regard, as other components and materials may be tested. While a PLC and computer have been described, the present invention is not limited in this regard as the loading device 14 can also be coupled to a digital or analog read out or can store data for later retrieval or transfer onto machine readable media for analysis by a computing device without departing from the broader aspects of the present invention.

The table 12 comprises a substantially planar surface 20 horizontally oriented to which devices holding and supporting the workpiece 16 can be secured. The planar surface 20 is mounted so as to be movable in perpendicular horizontal directions (i.e., the table 12 is a two-axis table). The present invention is not limited in this regard, as the table 12 may be movable in three directions (e.g., in perpendicular horizontal directions and further in a vertical direction). The planar surface 20 is movable in two or three directions using any suitable mechanism. The table 12 further comprises at least one workpiece holder 24 (the device for holding the workpiece 16) having at least one workpiece support 26 mounted on the planar surface 20. The table 12 and the load device 14 may be mounted on a table 28.

As is shown, the loading device 14 comprises a roller 30 for rollably engaging the workpiece 16. The roller 30 allows friction from the movement of the loading device 14 relative to the workpiece 16 to be minimized when carrying out a test procedure. The roller 30 is supported by any suitable structure extending from the loading device 14. The roller 30, the workpiece holder 24, and the workpiece support 26 are positionable relative to the table 12 to effect the desired orientation of the workpiece 16 for testing. The loading device 14 also includes an arm 70 to which a load cell 72 is attached. Movement of the loading device 14 is via the arm 70 and the load cell 72 and is effected by a motor 73 and a device 75 having a shaft 77 extendable therefrom.

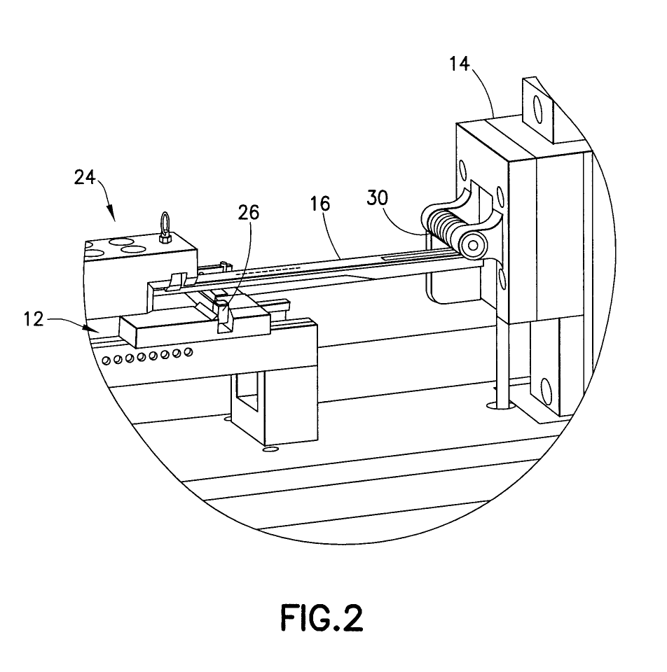

Referring now to FIG. 2, one end of the workpiece 16 is mounted in the workpiece holder 24. A surface of the workpiece 16 is placed against the workpiece support 26, which operates as a fulcrum during operation of the apparatus 10 during a test procedure. The end of the workpiece 16 opposite the end secured in the workpiece holder 24 is engaged by the roller 30. In preparation for the test procedure, the workpiece 16 is placed on the underside of the roller 30, and the loading device 14 is adjusted such that no (or negligible) pressure is exerted on the workpiece (no deflection of the workpiece is detected).

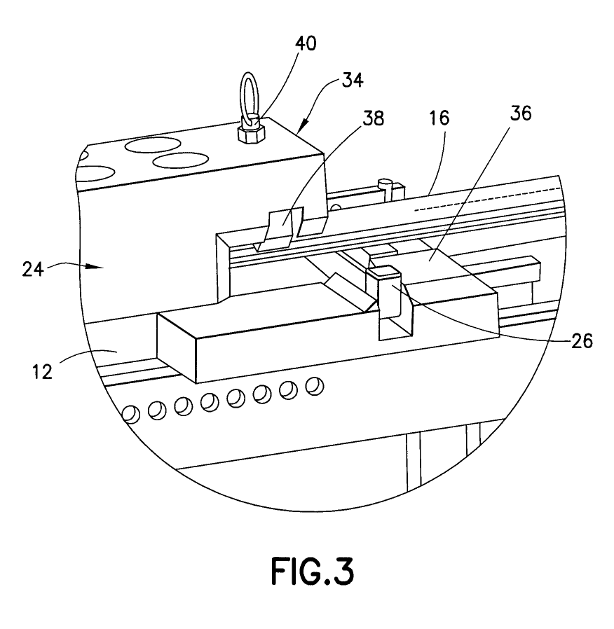

Referring now to FIG. 3, the workpiece holder 24 comprises an upper portion 34 to which the workpiece 16 can be connected and a cooperably-associated lower portion 36 containing the workpiece support 26. The workpiece 16 is mounted in the workpiece holder 24, for example, by being placed against a block 38 having a downward-facing substantially horizontally-oriented surface. A pin 40 may extend through the workpiece holder 24 to hold the workpiece 16 to the block 38. The upper portion 34 and the lower portion 36 are movable relative to each other on the table 12 to allow the workpiece 16 to engage and rest on the workpiece support 26.

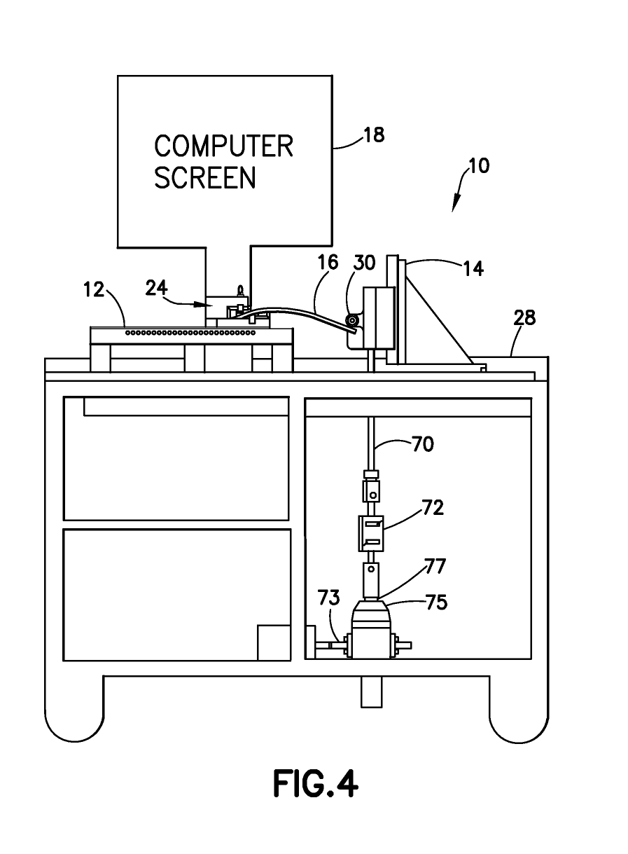

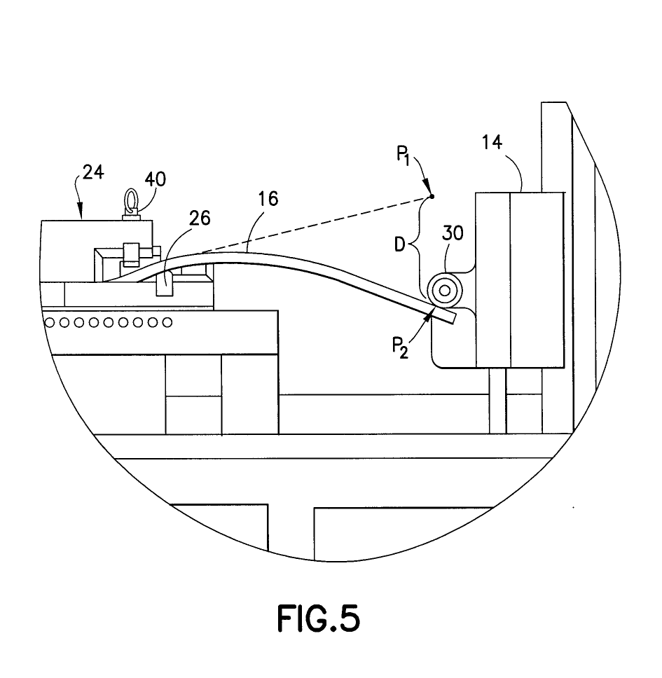

Referring now to FIGS. 4 and 5, during operation of the apparatus 10 to test the workpiece 16, the workpiece is secured in the workpiece holder 24 and is supported by the workpiece support 26. In being secured in the workpiece holder 24 and supported by the workpiece support 26, the workpiece 16 may extend at an angle relative to the horizontal plane. The workpiece 16 is then made to engage the roller such that no (or negligible) pressure is exerted on the workpiece. The load cell 72 is calibrated to show no load. To deflect and test the workpiece 16, the motor 73 is operated such that the device 75 retracts the arm 70 and causes the roller 30 to impinge on the workpiece, thereby deflecting the workpiece from a first position indicated by P₁. The workpiece 16 is then deflected a distance D to a second position P₂. The distance D is a factor in calculations carried out in the PLC 18 to measure the force used to deflect the workpiece 16.

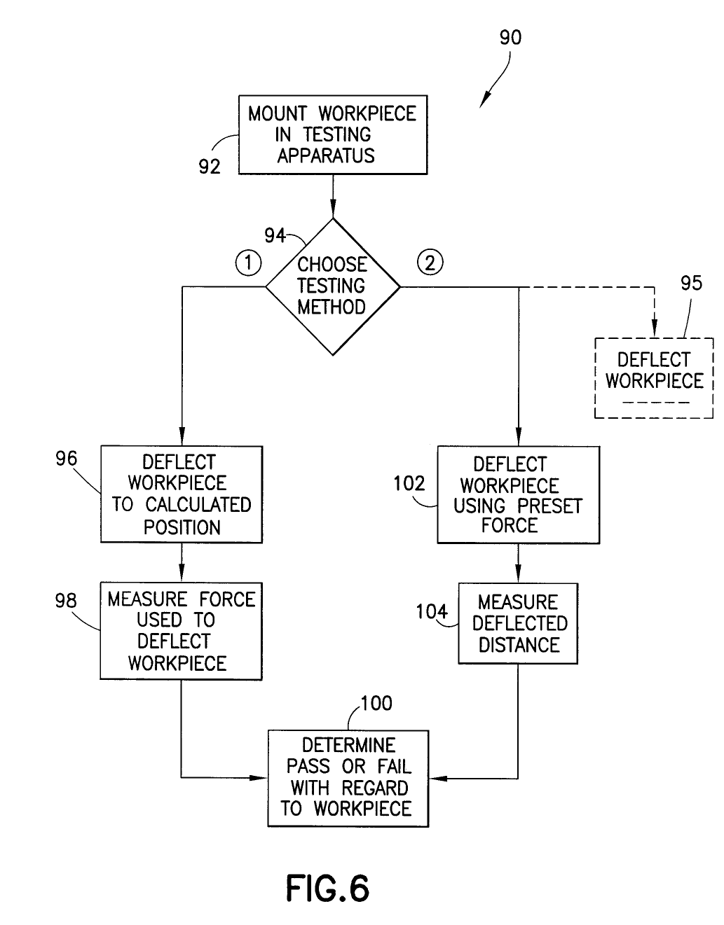

Referring now to FIG. 6, a process used to assess the testing of the workpiece 16 is designated generally by the reference number 90 and referred to as “process 90.” In process 90, the workpiece 16 is mounted in the apparatus 10 as described above in a mounting step 92. An operator chooses a testing method in an option step 94. Although the option step 94 presents only two options, the present invention is not limited in this regard as is shown generally at 95 any number of options may be presented.

As shown, the first option describes a testing process in which the workpiece 16 is deflected using the apparatus 10 and the force used to make the deflection is measured. In the first option, the workpiece 16 is deflected to a calculated, pre-selected position in a deflection step 96. The pre-selected position is calculated based on the type of material being tested, the properties of the material, and the expected results. One parameter of the calculation is based on the distance between the workpiece support 26 and the roller 30. The force used to deflect the workpiece 16 is then measured in a force measuring step 98. The load cell 72 is used to measure the force. The load cell 72 used may be of the mechanical type (e.g., hydraulic or pneumatic) or it may be a strain gage load cell. After measuring the force, a determination is made regarding whether or not the workpiece 16 passes or fails in a determination step 100.

The second option (following the option step 94) describes a testing process in which the workpiece 16 is deflected using a pre-selected amount of force and the distance the workpiece is deflected is measured. The deflection of the workpiece 16 is effected in a calculated deflection step 102. The pre-selected amount of force used is based on the type of material being tested, the properties of the material, and the expected results. The distance between the workpiece support 26 and the roller 30 may be a factor in determining the amount of force. Once the deflection step 102 is carried out, the distance the workpiece 16 is deflected is measured in a distance measuring step 104. Any suitable method for measuring the distance the workpiece 16 is deflected can be used. After the distance measuring step 104, a determination is made regarding whether or not the workpiece 16 passes or fails in the determination step 100.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. An apparatus for testing the ability of a material to deflect, the apparatus comprising:
a base:
a platform mounted to the base;
a workpiece holder mounted to the platform;
a fulcrum mounted to the platform;
an actuator mounted to the base and having a drive unit operably coupled thereto, the drive unit being coupled to a load transfer assembly and being operable to move the load transfer assembly relative to the base;
a load sensor in communication with the load transfer assembly and being operable to measure forces transmitted by the drive unit to the load transfer assembly;
a programmable data processor in communication with at least one of the load sensor, the actuator and the load transfer assembly.

2. (canceled)

3. The apparatus of claim 1, wherein the platform is movably mounted to the base.

4. The apparatus of claim 3, wherein the platform is configured to move in at least two directions, relative to the base.

5. The apparatus of claim 1, wherein the programmable data processor is operable to acquire information from at least one of the load sensor, the actuator and the load transfer assembly.

6. The apparatus of claim 1, wherein the programmable data processor is operable to control at least one of the load sensor, the actuator and the load transfer assembly.

7. The apparatus of claim 1, wherein at least one of a digital and an analog storage device is in communication with at least one of the load sensor, the actuator and the load transfer assembly and operable to acquire information therefrom.

8. The apparatus of claim 1, wherein the programmable data processor is operable to assess the ability of an object to deflect.

9. The apparatus of claim 1, wherein the load transfer assembly comprises a roller configured to contact and impart forces on an object positionable in the apparatus.

10. The apparatus of claim 1, wherein the fulcrum is positioned between the workpiece holder and a portion of the load transfer assembly.

11. The apparatus of claim 1, wherein the workpiece holder and a portion of the load transfer assembly are positionable on one side of a reference plane and the fulcrum is positioned on an opposite side of the reference plane.

12. The apparatus of claim 1, wherein the load sensor is at least one of a hydraulic sensor, a pneumatic sensor and a strain gauge.

13. The apparatus of claim 1, further comprising a deflection measuring device operable to measure deflection of an object positionable in the apparatus.

14. A method for deflection testing an object comprising:
providing a testing apparatus comprising a base, a platform mounted to the base, a workpiece holder mounted to the platform; a fulcrum mounted to the platform; an actuator mounted to the base and having a drive unit operably coupled thereto, the drive unit being coupled to a load transfer assembly and being operable to move the load transfer assembly relative to the base, a load sensor in communication with the load transfer assembly and a deflection measuring device;
positioning the object in the testing apparatus in a calibration configuration with the workpiece holder contacting a first side of the object at a first end of the object, a portion of the load transfer assembly contacting the first side of the object at a second end of the object and the fulcrum contacting an opposite side of the object at a position between the first end and second end;
securing a first end of the object in the workpiece holder; and
calibrating the load sensor.

15. The method of claim 14, further comprising:
deflecting the object to a predetermined position by applying a force to the second end with the portion of the load transfer assembly;
measuring the force with the load sensor.

16. The method of claim 15, further comprising:
determining if the force meets predetermined acceptance criteria.

17. The method of claim 14, further comprising:
applying a predetermined force to the second end by moving the portion of the load transfer assembly and thereby deflecting the object;
measuring the deflection of the object with the deflection measurement device.

18. The method of claim 17, further comprising:
determining if the deflection meets predetermined acceptance criteria.
